(19) United States
(12) Patent Application Publication
(10) Pub. No.: US 2009/0041450 A1
(43) Pub. Date: Feb. 12, 2009

(54) Slide copying device

(76) Inventor: Robert W. Fritts, Oak Park Heights, MN (US)

Correspondence Address: Robert W. Fritts, Apt. A215, 5450 Nolan Parkway, Oak Park Heights, MN, 55082, US

(21) Appl. No.: 11/890,150

(22) Filed: Aug. 6, 2007

(51) Int. Cl. G03B 17/00

(52) U.S. Cl. 396/428

(57) ABSTRACT

A photographic transparency copying device wherein a camera is positioned to focus on a transparency mounted on the outer wall of an open-top laterally closed light diffuser chamber, the location of which is continuously adjustable in three dimensions. A halogen bulb directs light into the top of the diffuser chamber.

### BACKGROUND OF THE INVENTION

This invention relates to a device and method for illuminating color slide images that are to be photographed for duplication. In particular, this invention represents an improvement over the device and method shown in my earlier U.S. Pat. No. 6,711,347, the disclosure of which is incorporated herein by reference.

One way to duplicate a slide is to project it on a screen and photograph the projected image, a technique that requires extra equipment and space. There are numerous attachments for digital cameras that hold a slide to be duplicated, but none include any source of light.

My earlier invention provides a tabletop workstation system that firmly mounts a camera to focus on a diffuse light-transmissive aperture, the size of a 35-mm. slide, in one panel of a multi-panel ight diffuser chamber having an open top and one open side. Sunlight open side so that diffuse reflection illuminates a slide positioned over the aperture. In order to block extraneous light that interferes with an operator's viewing, it is usually necessary to provide hood or shroud around the viewing area. The chamber is mounted on a slotted rack that is adaptable by means of shims and mounting bolts to accommodate different camera parameters, viz., lens axis height above camera base, minimum macro focus distance, and camera mounting distance from lens axis. Although this device is highly functional, the requirement of a shroud and adjustment of the various components using an assortment of shims is somewhat inconvenient.

### BRIEF SUMMARY OF THE INVENTION

The present invention provides an improved slide copier system that provides all the advantages of my earlier invention but is simpler, easier to use and more convenient to adjust.

As in my previous invention, light is directed into a light diffuser chamber so as to illuminate a slide positioned over an aperture in the front wall of the chamber. A camera (preferably a digital camera) is then positioned on a support platform, along which it can be moved so that its lens is aimed directly at the aperture.

The present invention incorporates as an improvement, connecting the support platform to a rail and mounting the diffuser chamber on the bifurcate horizontally positioned leg of an angle iron bracket. The vertically positioned bifurcate leg of the angle iron bracket is connected to the rail so that it is adjustably and continuously positionable in three dimensions (toward or away from the camera, up and down, and right and left).

As a further improvement over my previous invention, the diffuser chamber is laterally closed, and a quartz halogen lamp is positioned in the open top, thereby providing a higher degree of illumination while eliminating the use of a hood to block spillover light from the work area.

More specifically, the present invention may be defined as a device for copying colored photographic transparencies, comprising a camera support platform having a laterally extending apertured configuration for mounting a camera at a desired location. Legs elevate the platform with respect to the remainder of the device. A rail, connected to the support platform and extending at a right angle thereto, is provided with an apertured configuration along its length to permit attachment of a bracket at different locations. An angle iron bracket having bifurcate legs is positioned with one leg in a generally vertical position at right angles to the rail and connected thereto, with the other generally horizontal leg extending away from the rail. A light diffuser chamber is mounted on the horizontal leg of the bracket. This chamber has a diffuse white base from which extend a plurality of diffuse panels connected to each other. One of the panels is taller than the others and has an aperture confronting a camera positioned on the support platform. A halogen lamp is mounted in the open top of the light diffuser chamber. The light diffuser chamber may thus conveniently be moved vertically, horizontally, and toward or away from the camera support platform.

In the currently preferred embodiment of the invention, the diffuser chamber is laterally closed and symmetrical with respect to the panel having the aperture. Light is provided by a halogen bulb positioned at the top of the chamber and directed downward and away from the aperture in the front panel, so that any image of the bulb filament does not strike the aperture without prior diffuse reflection. the bulb occupies a substantial part of the open top of the chamber, the amount of light that escapes is minimized, and the fact that the aperture-containing panel is taller than the other panels still further shields the operator from annoying light spillover. This arrangement is thus more energy efficient and provides higher illumination of the slide aperture than was the case in my prior invention. This permits the recording camera to operate at a higher F stop and greater depth of field, a preference of most photographers.

### BRIEF DESCRIPTION OF THE DRAWINGS

Understanding of the invention will be facilitated by referring to the accompanying drawings, in which like numbers refer to like parts in the several views, and in which:

FIG. 1 is a perspective view of one embodiment of the support frame for the photographic transparency copier of my invention, showing the mounting bracket in exploded view;

FIG. 2 is a perspective view of another embodiment of the support frame for the copier of my invention, again showing the mounting bracket in exploded view;

FIG. 3 is a perspective view of the support frame of FIG. 1, taken from below and showing the manner of attaching the light diffuser chamber to the support frame of FIG. 1;

FIG. 4 is a perspective view of the support frame of FIG. 2 with a different apertured configuration in the camera support platform, showing the light diffuser chamber mounted on the frame and a camera mounted on the support platform;

FIG. 5 is an enlarged plan view of alignment plate 52 shown in FIGS. 2 and 4;

FIG. 6 is an edge view of the alignment plate shown in FIG. 5; and

FIG. 7 is a view of the aperture-containing panel of the diffuser chamber showing a modification to permit the copying of film segments.

### DESCRIPTION OF CURRENTLY PREFERRED EMBODIMENTS

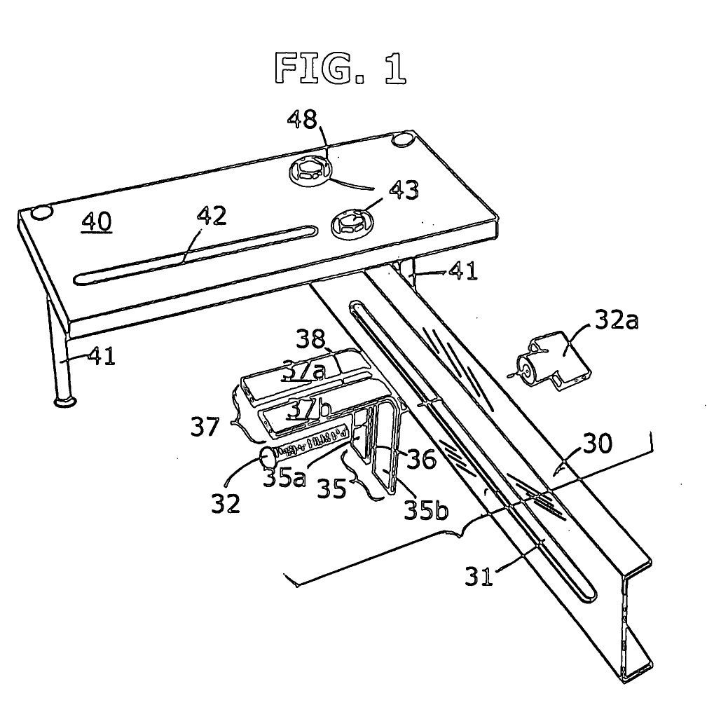

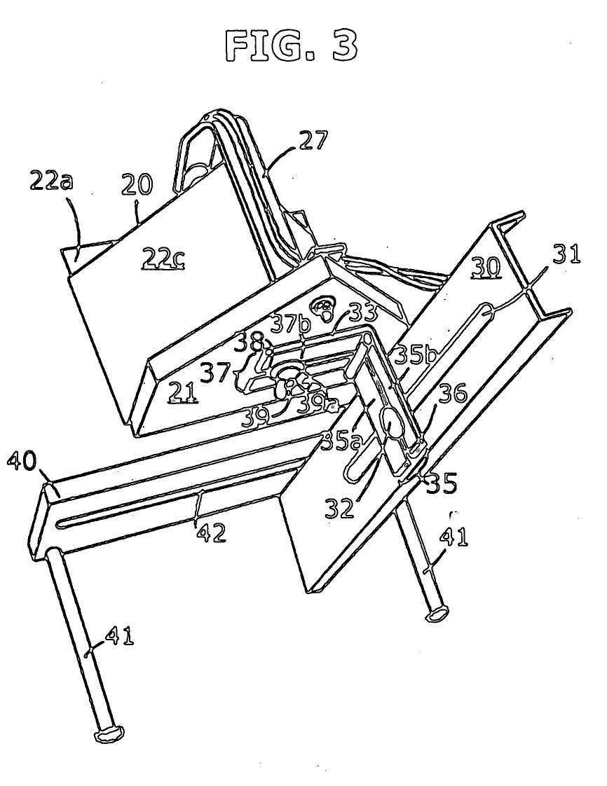

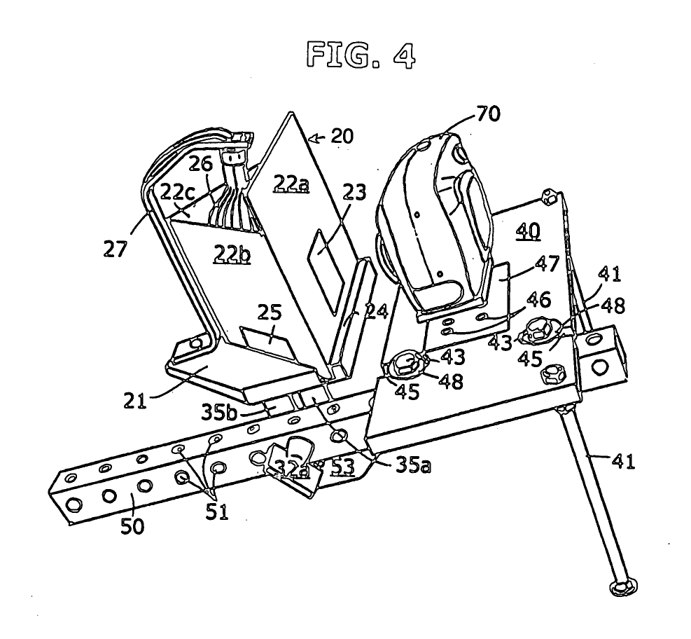

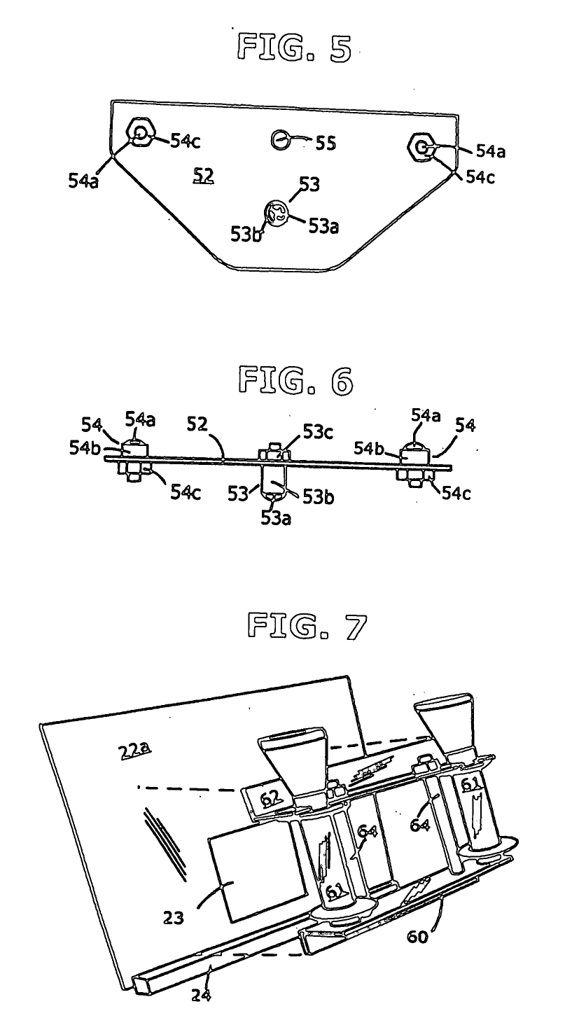

FIGS. 1 and 3 combine to show a device in accordance with the invention, comprising light diffusion chamber 20, rail 30, and camera support platform 40. Rail 30 is in the form of a channel iron having slot 31 extending along its length. Light diffusion chamber 20 is connected to rail 30 in a manner permitting it to be continuously adjustably positionable in three dimensions, as will subsequently be described in greater detail. Camera support platform 40 is fixedly connected to rail 30 by means of bolts 43 extending through washers 48 and holes 44. Legs 41 are connected to, and extend below, platform 40, tilting the device.

Diffuser chamber 20 comprises base 21, which supports panels 22a, 22b, and 22c, thereby defining a laterally closed open-top unit with aperture 23 in panel 22a. On the outer side of panel, 22a is transparency-supporting shelf 24. Halogen lamp 26, mounted on lamp support 27, is positioned at the open top of chamber 20 and tilted rearward, thereby insuring that no image of the lamp 26 filament will be imparted to a transparency positioned on shelf 24 without prior diffuse reflection. A 50-watt “Solux” 4700K quartz halogen lamp will enable exposures of 1/60 to 1/125 second for typical landscape scenes at f 6.6 for digital cameras set at ISO 80. As is shown in the drawings, panel 22a is taller than the remaining panels, substantially blocking any light flux into the camera-to-diffuser chamber area and obviating the need for a hood or shroud. The inner surfaces of light diffuser chamber 20 are provided with a flat white diffuse coating, thereby providing a uniform light source to illuminate aperture 23 and a transparency positioned on shelf 24. Louvers 25 in the lower parts of panels 22b and 22c, create a convection chimney that moves air upward and out of chamber 20 to reduce heat buildup.

As shown in FIGS. 1-4, platform 40 is provided with an apertured configuration permitting a camera to be positioned roughly in line with aperture 23 in diffuser chamber 20, and held in place with a screw (not shown) inserted through platform 40 and into the mounting hole of the camera. In FIGS. 1-3 the apertured configuration consists of slot 42, while in FIG. 4, it comprises a series of holes 45 at locations corresponding to the mounting holes of most cameras. To assist in maintaining camera 70 in position, a frictional layer 47 (e.g., 3M “Scotchtred” non slip sheeting) may be applied to the surface of platform 40. Platform constructions where holes 45 are used are more rigid and less prone to distortion than constructions where slot 42 is employed. On the other hand, platform constructions incorporating slot 42 permit mounting almost any camera in a desired location.

In FIGS. 1 and 3, rail 30 is in the form of a channel iron having, as an apertured configuration, slot 51 extending along its length. Bolts 43, provided with washers 48, connect camera support platform 40 to rail 30.

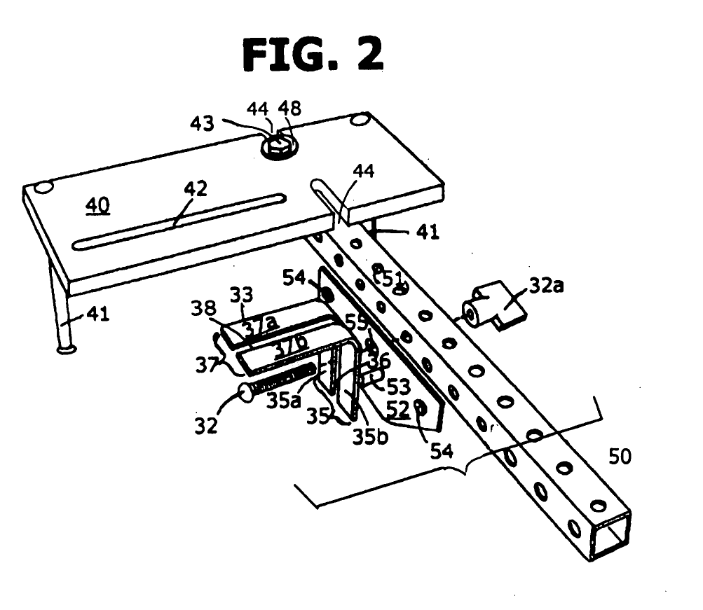

In FIGS. 2 and 4, rail 50 is a tubular steel piece having a square cross-section, with an apertured configuration comprising holes 39 spaced one inch apart spaced throughout its length. In this construction, platform 40 is provided with slotted holes 45 through which bolts 43, provided with washers 48, are inserted to connect platform 40 to rail 30. When slots 45 are one-half inch long, selection of the proper hole 39 and appropriate positioning of platform 40 along slotted holes 44 permits continuous adjustment of the distance from the lens of camera 70 to diffuser chamber 20.

As is shown in FIGS. 1-4, angle iron support bracket 33, comprising vertical member 35 and horizontal member 37, is attached to rail 30 or 50 with bolt 32 and wing nut 32a. For maximum convenience and vertical adjustability, vertical member 35 may be bifurcate, with legs 35a and 35b separated by slot 36. To permit fine tuning of the lateral alignment of aperture 34 with the lens of camera 70, horizontal member 37 may also be bifurcate, with legs 37a and 37b separated by slot 38. As is shown particularly in FIG. 3, diffusion chamber 20 is mounted on horizontal member 37 by inserting bolt 39 downward through base 21 of diffusion chamber 20 and through slot 38, where it is held in place by applying thumb screw 39a. Diffusion chamber 20 is then moved along slot 38 for precise lateral alignment with the lens of camera 70, which can be roughly aligned either by moving camera 70 along slot 42, as shown in FIGS. 1-3 or by mounting it in the most appropriate hole 46, as shown in FIG. 4.

In connecting angle iron bracket 33 to rail 30, bolt 32 is inserted through slot 36 of vertical member 35 and then through slot 31 of rail 30, after which wing nut 32a is applied to hold bracket 33 in position. Bracket 33 is then moved vertically to align aperture 23 with the lens of camera 70 and horizontally along slot 31 to achieve the proper distance from the lens of camera 70, after which nut 32a is tightened to hold the alignment in fixed position.

In connecting bracket 33 to rail 50, bolt 32 is inserted through slot 36 of vertical member 35 and then through the hole 39 that will most closely approximate the desired distance between aperture 23 and the lens of camera 70. Precise positioning is then achieved by moving rail 50 along slotted holes 44 in camera support table 40 before locking bolts 43 in position. Bracket 33 is then moved vertically to align aperture 23 with the lens of camera 70. In order to prevent inadvertent pivoting of light diffuser chamber 20 around bolt 32, it is desirable to interpose alignment plate 52 between vertical member 35 and rail 50. Alignment plate 52 includes hole 55, through which bolt 32 passes, and positioning pins 54, which fit into laterally spaced holes 39 to hold plate 52 in fixed position. Positioning pins 54 comprise bolt 54a, surrounded by bushing 54b and fitted with nut 52c. Alignment pin 53, comprising bolt 53a, bushing 53b and nut 53c, extends from plate 52 and passes through slot 36 to stabilize bracket 33. Alignment plate 52 can, of course, be used in the embodiment of the invention shown in FIG. 3.

In FIGS. 1 and 3, rail 30 is in the form of a channel iron having, as an apertured configuration, slot 51 extending along its length. In FIG. 4 rail 50 is in the form of a square cross-sectioned tubular member having, as an apertured configuration, spaced holes 51 extending along its length The advantage offered by rail 30 is that adjusting the distance between light diffusion chamber 20 and the lens of camera 70 is simple; a disadvantage is a tendency to twisting of rail 30 caused by the weight of light diffuser chamber 20. While somewhat less convenient in adjusting the distance between light diffusion chamber 20 and the lens of camera 70, rail 50's greater rigidity renders it resistant to deflection caused by twisting and resultant misalignment of aperture 30 with the lens of camera 70.

In FIG. 7, roll film accessory 60 is shown adjacent to aperture 23 of panel 22a. Accessory 60 comprises film spools 61 and guide rolls 64 mounted between upper support 62 and lower support 63. In order to copy roll film segments, accessory 60 is removably attached (e.g., with hook-and-loop fasteners) to panel 22a, lower support 60 resting on shelf 24.

Although the camera used in practicing the invention can be either film type or digital, it is anticipated that the use of digital cameras will be more popular. Many film photographers have accumulated libraries of bulky carousels containing slides and would like to convert them to compact discs, for which digital cameras provide the logical storage means. When a digital camera is employed, it should be set in macro mode, so that it will automatically focus on the transparency being copied.

My previous invention assumed that sunlight provided the best source of light for illuminating slides to be copied. It has been found, however, that not only is the availability of sunlight unreliable but also that sunlight tends to impart a color that is bluer than normal. This phenomenon results from the fact that transparency film manufacturers have traditionally established color balance standards so that their film customers might shoot under perfect sunlit condition and then project their images on a screen using a lamp having a bluedeficient hot tungsten filament and achieve screen pictures that look as though they were in sunlight.

To copy a transparency using the device of this invention, the transparency is positioned on support shelf 24, lamp 26 is turned on, and, with camera 70 set at auto focus and automatic exposure, the shutter is released. A different transparency is then placed on support shelf 24 and the process repeated. It has been found that as many as 250 transparencies can be copied in an hour.

Numerous variations to the illustrative examples herein can be made without departing from the spirit of the invention. For example, where specific dimensions have been used for purposes of illustration, it is to be understood that the invention is not restricted thereby. Similarly, although the dimensions of aperture 23 have been indicated as corresponding to 35-mm. slides, larger or smaller apertures might be appropriate for other sizes of film. Likewise, although diffuser chamber 50 has been shown as having three sides, more sides could be incorporated, or panels 22b and 22c could be combined into a single curved panel if desired. Other modifications will readily occur to those skilled in the art. Accordingly, the invention is limited only by the scope of the appended claims.

What is claimed is as follows:

1. In a device for copying photographic transparencies comprising in combination: a light diffuser chamber having a panel with an aperture over which a photographic transparency can be positioned and a support platform connected to said chamber for mounting a camera with its lens in alignment with said aperture,
the improvement comprising connecting said support platform and said diffuser chamber at desired locations along a rail, said support platform being attached to said rail, and said diffuser chamber being mounted on the horizontally positioned bifurcate leg of an angle iron bracket and the rail being attached to the vertically positioned bifurcate leg of said bracket to permit positioning of the diffuser chamber in the vertical and horizontal dimensions.

2. The invention of claim 1 wherein the rail is a channel iron provided with an apertured configuration comprising a slot extending along its length and is attached to a vertically positioned leg of said bracket by a bolt extending through the vertical bifurcate leg and the slot, whereby the diffuser chamber can be continuously moved laterally, vertically, and toward or away from the lens of a camera mounted on said support means to align the aperture with the camera lens and position it at the focal distance of the camera.

3. The invention of claim 1 wherein the light diffuser chamber is laterally closed and symmetrical with respect to the aperture, said chamber having an open top in which is positioned a halogen lamp.

4. The invention of claim 3 wherein louvers are incorporated in the walls of the diffuser chamber to permit heat from the halogen lamp to be carried upward by convection and out of the chamber.

5. The invention of claim 1 wherein the rail has a tubular square-shaped cross-section and is provided with an apertured configuration comprising holes spaced uniformly along its length, the camera support platform being connected to the rail through slots having a length equal to approximately one-half the distance between holes in the rail.

6. A device for copying colored photographic transparencies, comprising in combination:
a camera support platform having a laterally extending apertured configuration for mounting a camera at a desired location, said platform being provided with legs that elevate the platform with respect to the remainder of the device,
a rail connected to said support platform and extending at a right angle thereto, said rail being provided with an apertured configuration along its length to permit attachment of a bracket at different locations,
an angle iron bracket having bifurcate legs, one leg extending in a generally vertical direction at right angles to said rail and attached thereto, the other leg extending in a generally horizontal direction parallel to the camera support platform,
a light diffuser chamber mounted on the horizontal leg of said bracket, said chamber having a diffuse white base and an open top, a plurality of diffuse white panels connected to each other and extending upward from said base, one of said panels being the tallest and having an aperture confronting a camera mounted on the camera support platform, and
a halogen lamp mounted in the open top of the light diffuser chamber,
whereby said light diffuser chamber may be moved vertically, horizontally, and toward or away from the camera support platform.

7. The invention of claim 6 wherein the apertured configuration in the camera support platform comprises a slot extending laterally across the platform. for mounting cameras of different dimensions at a desired location.

8. The invention of claim 6 wherein the apertured configuration in the camera support platform comprises a series of spaced holes adapted to mounting cameras of different dimensions.

9. The invention of claim 8 wherein the rail is a tubular square cross-sectioned member having spaced holes throughout its length and is connected to the camera support platform by bolts extending through slotted holes in said platform, whereby the location of the diffuser chamber with respect to the lens of a camera mounted on said platform may be continuously varied by selecting the most appropriate hole in the rail and adjusting the location of the slots in the camera support platform to obtain the desired position of the light diffuser chamber with respect to the lens of a camera mounted on the support platform.

10. The device of claim 6 wherein an alignment plate is interposed between the rail and the bracket to prevent inadvertent rotation of the diffuser chamber.

11. The device of claim 10 wherein one side of the alignment plate is provided with positioning pins that fit into the apertured configuration in the rail and the other side is provided with an alignment pin that extends between the vertical legs of the support bracket.

12. The device of claim 9 wherein an alignment plate is interposed between the rail and the bracket to prevent inadvertent rotation of the diffuser chamber.

13. The device of claim 12 wherein one side of the alignment plate is provided with positioning pins that fit into spaced holes in the apertured configuration in the rail and the other side is provided with an alignment pin that extends between the vertical legs of the support bracket.
